(19) United States
(12) Patent Application Publication
(10) Pub. No.: US 2014/0239626 A1
(43) Pub. Date: Aug. 28, 2014

(54) BOOKMARK FOR OPEN SPINE BOOK

(71) Applicant: Rachel VanRoosendaal, Orem, UT (US)

(72) Inventor: Rachel VanRoosendaal, Orem, UT (US)

(21) Appl. No.: 13/776,544

(22) Filed: Feb. 25, 2013

(51) Int. Cl. B42D 9/00

(52) U.S. Cl. CPC B42D 9/004
USPC 281/42

(57) ABSTRACT

The present disclosure is drawn to a bookmark for an open spine book, comprising a clasp adapted to removably attach to a thin spine structure of the open spine book; a paginator; and a tether attaching the paginator to the clasp. In one specific example, the bookmark further comprises a second paginator attached to the clasp by a second tether.

### BACKGROUND

Bookmarks are typically made from materials such as paper stock, plastic, leather, fabric, or the like, and are used to mark the place where a reader left off reading prior to putting a book down for a period of time. Thus, upon returning to the book, the reader can then pick up the story or information at the same location with ease. There are a few types of bookmarks that are generally used. The most common is the detached bookmark that is simply placed in the book and removed when not in use. Others include attached bookmarks that are generally bound to the spine of the book. An example of this is a ribbon bookmark that may be attached to the spine of a bible or other book, providing a convenient bookmark that is never separated from the book. A third type of bookmark is the detachable bookmark, which can be attached and detached from a book, providing some of the benefits of both attached and detached bookmarking systems.

### SUMMARY

The present disclosure is drawn to a bookmark for an open spine book, comprising a clasp adapted to removably attach to a thin spine structure of the open spine book; a paginator; and a tether attaching the paginator to the clasp.

In another example, a method of temporarily marking a page in an open spine book can comprise steps of obtaining a bookmark and marking a page in the open spine book using the bookmark. The bookmark can include a clasp adapted to removably attach to a thin spine structure of the open spine book, a paginator, and a tether attaching the paginator to the clasp. In use, the step of attaching the clasp to a thin spine structure of the open spine book, and marking the page using the paginator that is tethered to the open spine book can be carried out.

In another example, a system for temporarily marking a page in an open spine book can comprise a bookmark and an open spine book. The bookmark can include a clasp adapted to removably attach to a thin spine structure of the open spine book, a paginator, and a tether attaching the paginator to the clasp. The open spine book can include an open spine suitable for receiving and holding in place the clasp.

### BRIEF DESCRIPTION OF THE DRAWINGS

Additional features and advantages of the disclosure will be apparent from the detailed description which follows, taken in conjunction with the accompanying drawings, illustrating by way of example, features of the invention; and, wherein:

FIG. 1 illustrates a bookmark for marking a page of an open spine book in accordance with examples of the present disclosure;

FIG. 2 illustrates a bookmark for marking multiple pages of an open spine book in accordance with examples of the present disclosure; and

FIG. 3 illustrates a system for marking pages of an open spine book in accordance with examples of the present disclosure.

### DETAILED DESCRIPTION

Reference will now be made to the exemplary embodiments, and specific language will be used herein to describe the same. It will nevertheless be understood that no limitation of the scope of the disclosure is thereby intended. Alterations and further modifications of the inventive features illustrated herein, and additional applications of the principles of the disclosures as illustrated herein, which would occur to one skilled in the relevant art and having possession of this disclosure, are to be considered within the scope of the disclosure. It is also to be understood that the terminology used herein is used for the purpose of describing particular embodiments only. The terms are not intended to be limiting unless specified as such.

The singular forms “a,” “an,” and, “the” include plural referents unless the context clearly dictates otherwise. Thus, for example, reference to “a tether” includes reference to one or more of such tethers, and reference to “the bookmark” includes reference to one or more of such bookmarks.

As used herein, the term “about” is used to provide flexibility to a numerical range endpoint by providing that a given value may be “a little above” or “a little below” the endpoint.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 to about 5” should be interpreted to include not only the explicitly recited values of about 1 to about 5, but also include individual values and sub-ranges within the indicated range. Thus, included in this numerical range are individual values such as 2, 3, and 4 and sub-ranges such as from 1-3, from 2-4, and from 3-5, etc., as well as 1, 2, 3, 4, and 5, individually. This same principle applies to ranges reciting only one numerical value as a minimum or a maximum. Furthermore, such an interpretation should apply regardless of the breadth of the range or the characteristics being described.

In accordance with these definitions and embodiments of the present disclosure, a discussion of the various devices, systems, and methods is provided including details associated therewith. This being said, it should be noted that various embodiments will be discussed as they relate to the devices, systems, and methods. Regardless of the context of the specific details as they are discussed for any one of these embodiments, it is understood that such discussion relates to other all other embodiments as well.

The present disclosure is drawn to a bookmark for an open spine book, comprising a clasp adapted to removably attach to a thin spine structure of the open spine book; a paginator; and a tether attaching the paginator to the clasp. In one specific example, the bookmark further comprises a second paginator attached to the clasp by a second tether.

In another example, a method of temporarily marking a page in an open spine book can comprise obtaining a bookmark including a clasp adapted to removably attach to a thin spine structure of the open spine book, a paginator, and a tether attaching the paginator to the clasp. Additional steps can include attaching the clasp to a spine structure of the open spine book, and marking a page in the open spine book using the paginator that is tethered to the open spine book. In one specific example, the bookmark further comprises a second paginator attached to the clasp by a second tether, and the method includes marking a second page in the open spine book using the second paginator.

In another example, a system for temporarily marking a page in an open spine book can comprise a bookmark and an open spine book. The bookmark can include a clasp adapted to removably attach to a thin spine structure of the open spine book, a paginator, and a tether attaching the paginator to the clasp. The open spine book can include an open spine suitable for receiving and holding in place the clasp. In one specific example, the bookmark further comprises a second paginator attached to the clasp by a second tether.

Turning now to the FIGS., additional detail is shown and described therein. For example, FIG. 1 shows a clasp 10 tethered to a paginator 30 via a tether 20. These types of bookmarks are used primarily with open spine books. Specifically, the term “open spine” refers to the spine of many books (which includes booklets, notebooks, notepads, binders, etc.) where the bound edge of the paper or other media held within the book is not glued or otherwise adhered within the spine of the book. Examples include spiral bound books, ring binders, comb bound books, twin loop bound books, etc. Additionally, these types of books are characterized by having a thin metal or plastic binding system that attaches the paper in the book along the spine (near the edge), but which does not typically use glues or other adhesion techniques to bind the spine at the paper's edge. Instead, holes are punched in the paper or media next to the paper's edge, and the open spine structure is attached to the paper or media using those holes. Stated another way, an “open spine” book does not bind the pages in the book at the paper's edge, but rather, near the edge using punched holes or other similarly modified paper. With these types of systems where there are typically thin or relatively thin metal or plastic structures along the spine, the clasps of the present disclosure are particularly adapted to attach to these types of spines. Thus, a “thin spine structure” refers to the material used to bind the paper together in an open spine book only, including wire, rings, combs, loops, etc. A “thin spine structure” does not include structures inherently present on traditionally glue-bound books, such as material overhangs, folds, etc.

The clasp 10 can be any of a number of clasping devices that can be opened and closed on so as to attach to a thin spiral, comb, coil, looseleaf ring, tube, twin loop, etc. In the example shown in FIG. 1, the clasp is a ring clasp having a spring-loaded closing member 12 that is actuated using a handle 14. The clasp further includes an eyelet 16 for attaching the tether 20 to the clasp. The clasp could likewise be any of a number of other systems that allow a user to open and close the device about a thin wire or other similar structure used on an open spine book. For examples, various openable and closable clips would likewise be considered “clasps” in accordance with examples of the present disclosure.

In another aspect, the tether 20 can be formed using any of a number of materials. To illustrate, the tether can comprise a metal wire, a fabric strip, a ribbon, a string, a cord, leather, synthetic leather or vinyl, plastic, rubber, combinations of these materials, etc. In one example a thin wire might be used with a plastic or rubber tube positioned about the wire to protect the wire from breaking. Alternatively, a strip of leather might be used with a ribbon to provide an aesthetic look to the tether structure.

The tether 20 can be fastened to either the clasp 10 or the paginator 30 by any technique known in the art, such as by hand tying, machine tying, sewing, braiding, gluing, riveting, tacking, buttoning, snapping, clipping, clasping, crimping, etc. In one specific example, a thin flexible wire 20 can be looped through the eyelet 16 on the clasp 10, or through a hole 32 on the paginator 30, and the wire crimped on itself using a crimp 24 and a crimping tool (not shown). Additionally, as mentioned, the thin flexible wire may be surrounded along a portion or all of its length by a protective tube 26, which can be made of any material that provides the flexibility desired for a specific embodiment. For example, the protective tube might be prepared from metal, plastic, rubber, paper, fabric, or the like. In one example, the protective tube can be a soft rubber or plastic. Likewise, the paginator, which typically has a flat configuration, can be prepared from any of a number of materials, including metal, plastic, rubber, paper, fabric, wood, etc., and can have any practical shape, including rectangular as shown, or any other geometric shape imaginable, e.g., 2-D representations of other shapes or even objects (cars, instruments, people, interests, etc.).

The length of the tether 20 can be such that it can easily be used to maneuver the paginator 30 around the top (or bottom if attached near the bottom) of the book and reposition the paginator at a different page, without removing the clasp. For example, the tether can have a length ranging from ½ inch to 5 inches, and the paginator can likewise have a length from ½ inch to 5 inches, though these lengths are not intended to be particularly limiting. In one example, the length of the tether and the length of the paginator can be prepared at a ratio from 2:1 to 1:2, and in another example, the ration can be about 1:1 (e.g., 20% of 1:1).

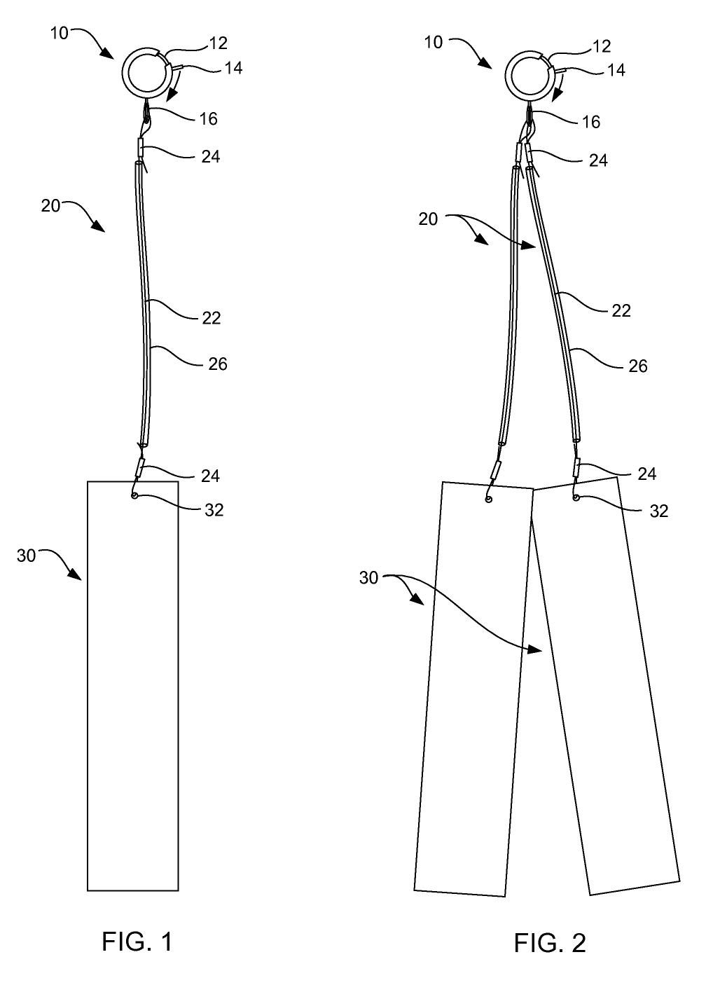

Turning now to FIG. 2, all of the same reference numerals used in describing the structure of FIG. 1 is also applicable to the structure of FIG. 2. However, as shown, though there is only one clasp 10, there are two tethers 20 and two paginators 30. Thus, a single clasp can be used to anchor the tethers and the paginators to the open spine of the open spine book, e.g., a spinal bound notebook. Furthermore, though two tethers and two paginators are shown, any practical number of paginators can be tethered to a single clasp, for example, from 1 to 20 paginators may be present on a common clasp, or alternatively, from 2 to 20 paginators may be present on a common clasp, though these ranges are not intended to be particularly limiting.

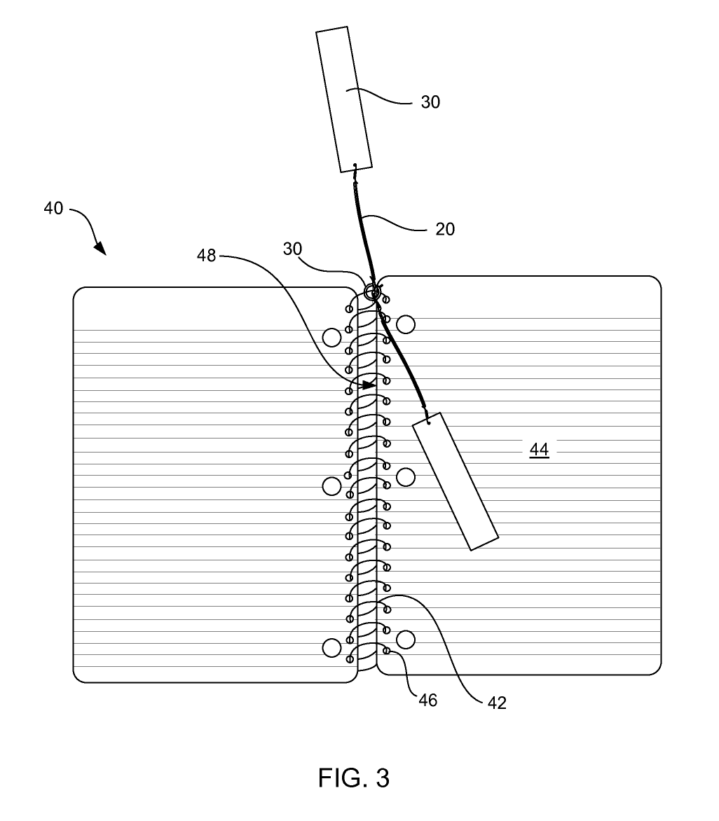

Turning now to FIG. 3, an embodiment where a spiral notebook 40 is shown by way of example is provided. The spiral notebook is an example of an open spine book having a thin wire spiral spine 42 (metal wire, coated metal wire, plastic wire, etc.) that binds the paper 44 together along a plurality of holes 46 next to a binding edge 48 of the paper. Again, this is considered to be an open spine book because the binding edge of the paper is not bound and glued together along the edge, but rather, is bound near the edge at the holes.

Also shown in FIG. 3 is a bookmark similar to that shown in FIG. 2, which includes a clasp 10, two tethers 20, and two paginators 30. Thus, multiple pages within the open spine book can be marked, as desired. Also, as shown, the clasp is removably attached to the thin wire spiral spine 42. It is noted that the term “removably attached” refers to clasps that can be attached, unattached, and reattached again and again, and does not include attachment and unattachment where the clasp is damage for removal.

Of course, it is to be understood that the above-described arrangements are only illustrative of the application of the principles of the present disclosure. Numerous modifications and alternative arrangements may be devised by those skilled in the art without departing from the spirit and scope of the present disclosure and the appended claims are intended to cover such modifications and arrangements. Thus, while the present disclosure has been described above with particularity and detail in connection with what is presently deemed to be the most practical embodiments of the disclosure, it will be apparent to those of ordinary skill in the art that numerous modifications, including, but not limited to, variations in size, materials, shape, form, function and manner of operation, assembly and use may be made without departing from the principles and concepts set forth herein.

What is claimed is:

1. A bookmark for an open spine book, comprising:
a clasp adapted to removably attach to a thin spine structure of the open spine book;
a paginator; and
a tether attaching the paginator to the clasp.

2. The bookmark of claim 1, wherein the tether comprises a thin wire.

3. The bookmark of claim 2, further comprising a protective tube positioned about the thin wire.

4. The bookmark of claim 3, wherein the protective tube is a soft, flexible rubber or plastic.

5. The bookmark of claim 2, wherein the thin wire is attached to a least one of the clasp or the paginator using a crimp.

6. The bookmark of claim 1, wherein the tether comprises fabric, string, ribbon, cord, leather, synthetic leather, vinyl, plastic, rubber, or combinations thereof.

7. The bookmark of claim 1, wherein the clasp is spring loaded.

8. The bookmark of claim 1, further comprising a second paginator attached to the clasp by a second tether.

9. The bookmark of claim 1, wherein clasp is adapted to attach to a thin spine structure of the open spine book.

10. A method of temporarily marking a page in an open spine book, comprising:
obtaining a bookmark including:
a clasp adapted to removably attach to a thin spine structure of the open spine book,
a paginator, and
a tether attaching the paginator to the clasp;
attaching the clasp to the thin spine structure; and
marking a page in the open spine book using the paginator that is tethered to the open spine book.

11. The method of claim 10, wherein the open spine book is spiral bound, comb bound, ring bound, or twin loop bound.

12. The method of claim 11, wherein the open spine book is a spiral notebook.

13. The method of claim 11, wherein the open spine book is a 3-ring binder.

14. The method of claim 10, wherein the bookmark further comprises a second paginator attached to the clasp by a second tether, and wherein the method includes marking a second page in the open spine book using the second paginator.

15. A system for temporarily marking a page in an open spine book, comprising:
a bookmark including:
a clasp,
a paginator, and
a tether attaching the paginator to the clasp; and
an open spine book having a thin spine structure suitable for receiving and holding in place the clasp.

16. The system of claim 15, wherein the open spine book is spiral bound, comb bound, ring bound, or twin loop bound.

17. The system of claim 16, wherein the open spine book is a spiral notebook.

18. The system of claim 16, wherein the open spine book is a 3-ring binder.

19. The system of claim 15, wherein the bookmark further comprises a second paginator attached to the clasp by a second tether.

20. The system of claim 15, wherein the tether comprises a thin wire and further comprises a protective tube positioned about the thin wire.
